(19) United States
(12) Patent Application Publication
(10) Pub. No.: US 2016/0221171 A1
(43) Pub. Date: Aug. 4, 2016

(54) HYDRAULIC HAMMER HAVING DUAL VALVE ACCELERATION CONTROL SYSTEM

(71) Applicant: CATERPILLAR INC., Peoria, IL (US)

(72) Inventors: Austin William Neathery, Waco, TX (US); Vaino Esko Juvonen, Espoo (FI); Cody Thomas Moore, Waco, TX (US)

(73) Assignee: CATERPILLAR INC., Peoria, IL (US)

(21) Appl. No.: 14/611,472

(22) Filed: Feb. 2, 2015

(51) Int. Cl. B25D 9/16

(52) U.S. Cl. CPC B25D 9/16

(57) ABSTRACT

A hydraulic hammer may have a housing and a piston configured to reciprocate within the housing. The hydraulic hammer may also have an acceleration channel formed within the housing. The acceleration channel may be configured to receive a pressurized fluid for accelerating the piston in a first direction. The hydraulic hammer may further have a first valve in communication with the acceleration channel. The first valve may be configured to selectively supply a first portion of the pressurized fluid to the acceleration channel. The hydraulic hammer may also have a second valve in communication with the acceleration channel. The second valve may be configured to selectively supply a second portion of the pressurized fluid to the acceleration channel.

### TECHNICAL FIELD

The present disclosure relates generally to a hydraulic hammer, and more particularly, to a hydraulic hammer having a dual valve acceleration control system.

### BACKGROUND

Hydraulic hammers for milling stone, concrete, and other materials may be mounted to various machines (e.g., excavators, backhoes, tool carriers, and other types of machines). For example, a hydraulic hammer may be mounted to a boom of a machine and connected to the machine's hydraulic system. High pressure fluid in the hydraulic system may be supplied to the hammer to drive a piston of the hammer in a reciprocating manner. The piston may, in turn, drive a work tool in a reciprocating manner, causing the work tool to mill material it contacts.

An exemplary hydraulic hammer is disclosed in U.S. Patent Application Publication No. 2009/0321100 by Anderson, published Dec. 31, 2009 (“the '100 publication”). Specifically, the '100 publication discloses a fluid operated percussive device having a piston that slides in a cylinder room. The percussive device also has a main valve and an auxiliary valve for controlling the movement of the piston. The main valve is adapted to transmit pressure fluid to a driving chamber for the percussive piston. The auxiliary valve is adapted to switch the main valve.

Although the percussive device of the '100 publication may be suitable for some applications, it may be less than optimal for others. For example, for a large hydraulic hammer (e.g., one weighing more than 1000 kg), which has a correspondingly large piston, the main valve must be very large in size to allow sufficient fluid transfer to move the piston without increasing the fluid supply pressure. For a large hammer it becomes impractical to locate the main valve around the piston as is commonly done for smaller hammers because of the size and weight of the large main valve. Often a separate housing is utilized to house the large main valve, but this too is less than optimal because of the increased cost and complexity associated with the additional housing. The disclosed embodiments may help solve these and/or other problems known in the art.

### SUMMARY OF THE INVENTION

One disclosed embodiment is related to a hydraulic hammer, which may include a housing and a piston configured to reciprocate within the housing. The hydraulic hammer may also include an acceleration channel formed within the housing. The acceleration channel may be configured to receive a pressurized fluid for accelerating the piston in a first direction. The hydraulic hammer may further include a first valve in communication with the acceleration channel. The first valve may be configured to selectively supply a first portion of the pressurized fluid to the acceleration channel. The hydraulic hammer may also include a second valve in communication with the acceleration channel. The second valve may be configured to selectively supply a second portion of the pressurized fluid to the acceleration channel.

Another disclosed embodiment is related to a valve control system for a piston associated with an acceleration channel. The valve system may include a first valve in communication with the acceleration channel. The first valve may be configured to selectively supply a first portion of a pressurized fluid to the acceleration channel. The valve system may also include a second valve in communication with the acceleration channel. The second valve may be configured to selectively supply a second portion of the pressurized fluid to the acceleration channel only after the first valve begins to supply the first portion of the pressurized fluid.

Yet another disclosed embodiment is related to a valve control system for a piston associated with an acceleration channel. The valve system may include a first valve in communication with the acceleration channel. The first valve may be configured to selectively supply a first portion of a pressurized fluid to the acceleration channel. The valve system may also include a second valve in communication with the acceleration channel. The second valve may be configured to selectively supply a second portion of the pressurized fluid to the acceleration channel. The first valve and the second valve may be configured to supply the first portion and the second portion of the pressurized fluid independently of each other and based on a position of the piston.

### BRIEF DESCRIPTION OF THE DRAWINGS

FIG. 1 is a perspective view of an exemplary disclosed machine;

FIG. 2 is a schematic view of a portion of an exemplary disclosed hydraulic hammer of the machine of FIG. 1;

FIG. 3 is a top view of a portion of the exemplary disclosed hydraulic hammer of FIG. 2;

FIG. 4 is a schematic illustration of a first embodiment of an exemplary disclosed dual valve acceleration control system of the hydraulic hammer of FIG. 2;

FIG. 5 is a schematic illustration of a second embodiment of an exemplary disclosed dual valve acceleration control system of the hydraulic hammer of FIG. 2 in a first state of operation;

FIG. 6 is a schematic illustration of the dual valve acceleration control system of FIG. 5 in a second state of operation; and

FIG. 7 is a schematic illustration of the dual valve acceleration control system of FIG. 5 in a third state of operation.

### DETAILED DESCRIPTION

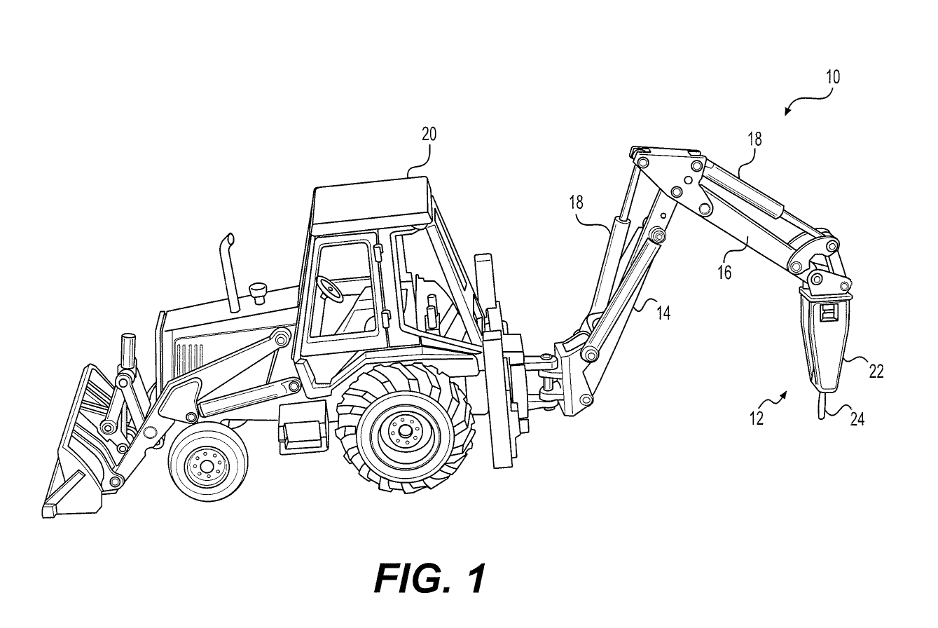

FIG. 1 illustrates an exemplary disclosed machine 10 having a hydraulic hammer 12. Machine 10 may be configured to perform work associated with a particular industry such as, for example, mining or construction. Machine 10 may be a backhoe loader (shown in FIG. 1), an excavator, tool carrier, a skid steer loader, or any other type of machine. Hammer 12 may be pivotally connected to machine 10 through a boom 14 and a stick 16. Alternatively, hammer 12 may be connected to machine 10 in another way.

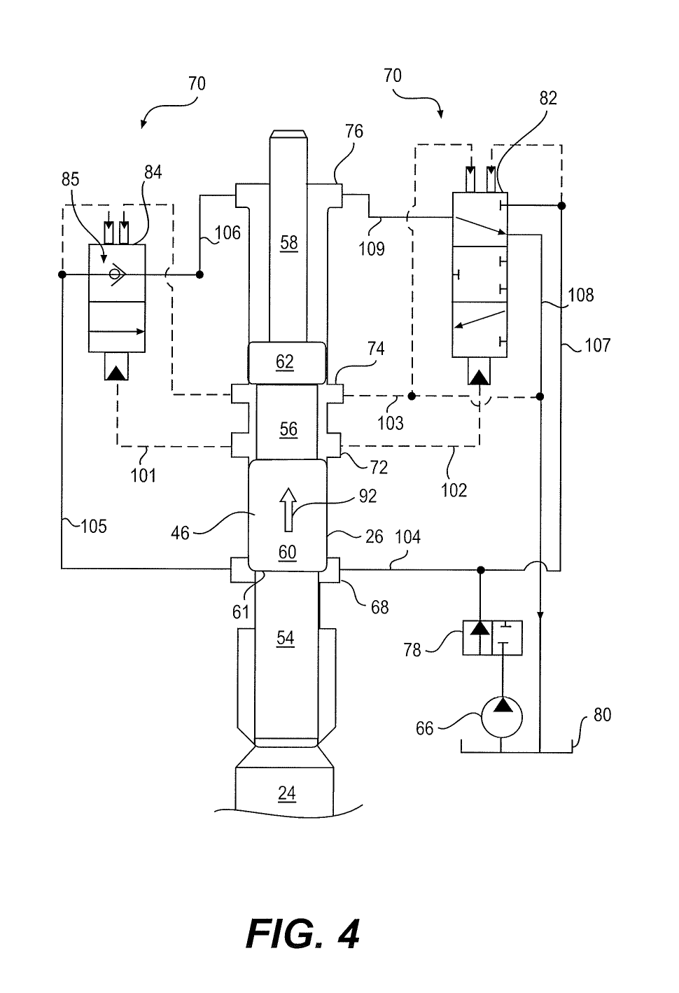

Machine 10 may include a hydraulic supply system (not shown in FIG. 1) for moving and powering hammer 12. For example, machine 10 may include a pump 66 (see FIGS. 4-7) connected through one or more hydraulic supply lines (see FIGS. 4-7) to hydraulic cylinders 18 associated with boom 14 and stick 16, and to hammer 12. The hydraulic supply system may supply pressurized fluid, for example oil, from the pump to the hydraulic cylinders 18 and hammer 12. Hydraulic cylinders 18 may raise, lower, and/or swing boom 14 and stick 16 to correspondingly raise, lower, and/or swing hammer 12. Operator controls for movement of hydraulic cylinders 18 and/or hammer 12 may be located within a cabin 20 of machine 10.

As shown in FIG. 1, hammer 12 may include a housing 22, which may be connected to stick 16. A work tool 24 may be operatively connected to an end of housing 22 opposite stick 16. It is contemplated that work tool 24 may include any tool capable of interacting with hammer 12. For example, work tool 24 may include a chisel bit, moil point, percussion buster, blunt tool, ramming tool, tamping plate, cutter, or other bit.

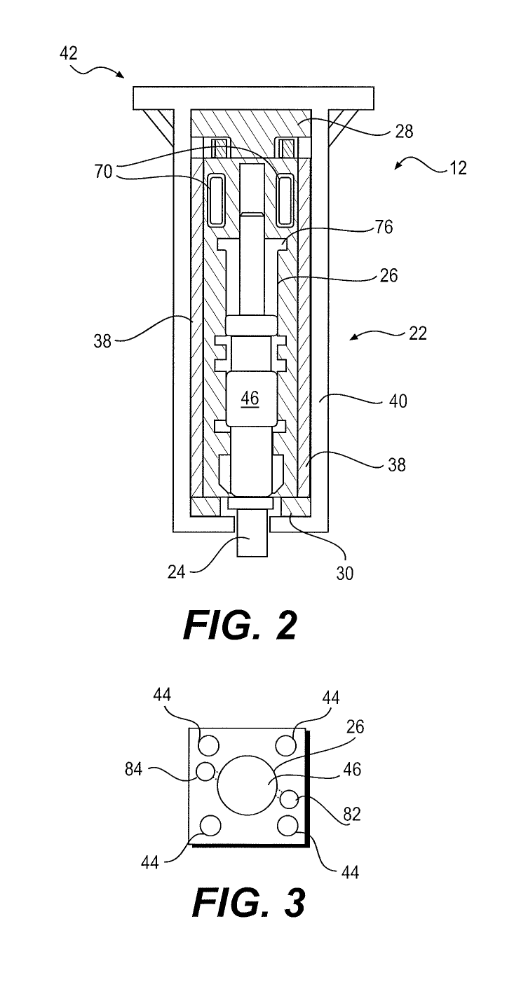

As shown in FIG. 2, hammer 12 may have a piston 46 and a cylinder 26 within housing 22. Piston 46 may be configured to move back and forth within cylinder 26 to impact work tool 24. Hammer 12 may also include a dual valve acceleration control system 70 to control the movement of piston 46. System 70 may do so by controlling the flow of pressurized fluid from pump 66 (see FIGS. 4-7) of machine 10 to an acceleration channel 76. As pressurized fluid flows to acceleration channel 76, it imparts a force on piston 46 and may drive piston 46 toward work tool 24.

Still referring to FIG. 2, housing 22 may include, among other things, a frame 40 and a head 42. Frame 40 may be a generally hollow body having one or more flanges or steps along its axial length. Head 42 may cap off one end of frame 40. Specifically, one or more flanges on head 42 may couple with one or more flanges on frame 40 to provide a sealing engagement. One or more fasteners (not shown) may rigidly attach head 42 to frame 40. For example, the fasteners may include screws, nuts, bolts, tie rods, or any other fastener(s) capable of securing the two components. Additionally, cylinder 26 may include holes to receive the fasteners (e.g., holes 44, shown in FIG. 3) which may correspond with holes in head 42.

Hammer 12 may also include a back buffer 28, a front buffer 30, and isolation sliding plates 38, all within housing 22. As shown in FIG. 2, front buffer 30 may be positioned within frame 40 between cylinder 26 and frame 40. Back buffer 28 may be positioned within frame 40 between head 42 and cylinder 26. Isolation sliding plates 38 may be positioned between frame 40 and cylinder 26, and may be configured to extend along an inner wall of frame 40 from front buffer 30 toward back buffer 28. As shown in FIG. 2, isolation sliding plates 38 may extend up to and beyond cylinder 26. Isolation sliding plates 38 may be configured to absorb noise and vibration and to work as sliding and wearing plates, which enable small axial movements of cylinder 26 when milling material.

As shown in FIGS. 4-7, piston 46 may comprise varying diameter sections along its length, for example one or more narrow diameter sections disposed between wider diameter sections. Piston 46 may include three narrow diameter sections 54, 56, 58, separated by two wide diameter sections 60, 62. Narrow diameter sections 54, 56, 58 may cooperate with the inner wall of cylinder 26 to selectively open and close fluid pathways (e.g., passages 101, 102, and 103) of dual valve acceleration control system 70.

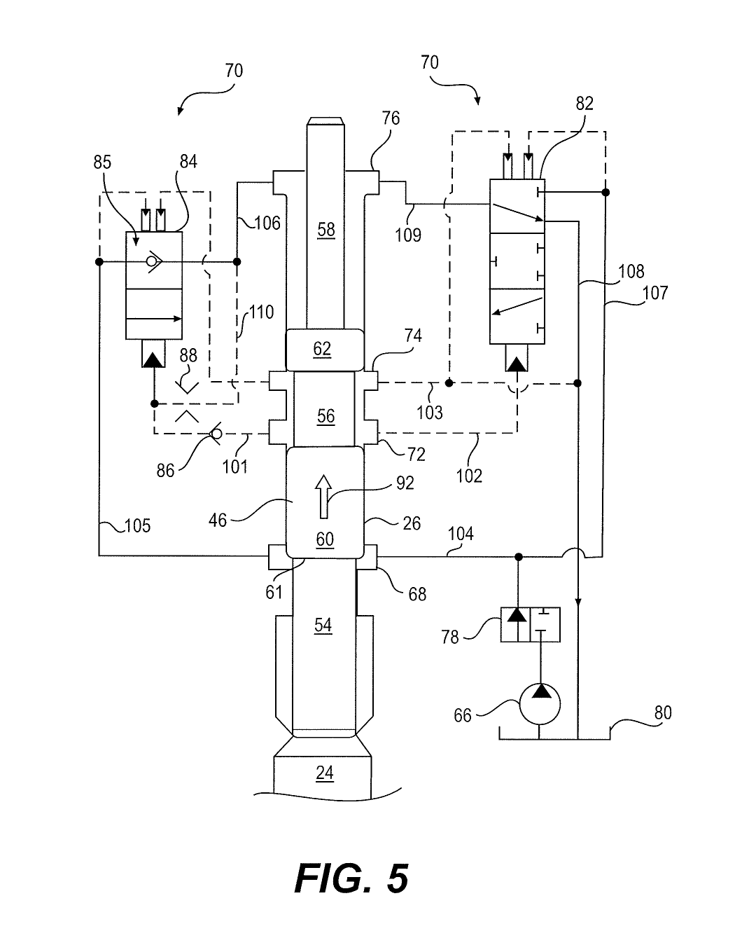

As shown in FIGS. 4-7, dual valve acceleration control system 70 may include an annular lift channel 68, an annular switch channel 72, an annular tank channel 74, an acceleration channel 76, a first valve 82, a second valve 84, and numerous fluid passages (e.g., passages 101-109) interconnecting the components. FIG. 4 shows a first embodiment of dual valve acceleration control system 70 and FIG. 5 shows a second embodiment of dual valve acceleration control system. The difference between the first embodiment shown in FIG. 4 and the second embodiment shown in FIGS. 5 is the addition of a check valve 86, an orifice 88, and a passage 110 to the second embodiment. These three elements of the second embodiment are associated with second valve 84 and affect how movement of second valve 84 is triggered. All other elements of dual valve acceleration control system 70 may be the same for both embodiments. Accordingly, FIGS. 5, 6, and 7, which show different states of operation for the second embodiment, are equally applicable to the first embodiment of FIG. 4 for all of the same components. In both the first embodiment and the second embodiment, dual valve acceleration control system 70 may be fluidly connected to pump 66, an operator valve 78, and a tank 80, which may be housed in machine 10.

As shown in FIGS. 4 and 5, pump 66 may be configured to draw fluid from tank 80 and discharge a pressurized fluid. The pressurized fluid from pump 66 may be selectively directed through operator valve 78 to lift channel 68 via passage 104, first valve 82 via passage 107, and second valve 84 via passage 105. Lift channel 68 may be configured to direct the pressurized fluid to contact a shoulder 61 at wide diameter section 60 in order to force piston 46 in an upward second direction 92. Switch channel 72 may be configured to fluidly communicate via passage 102 with first valve 82 to move the valve position of first valve 82. As shown in FIGS. 4 and 5, tank channel 74 via passage 103 may be configured to drain pressurized fluid to tank 80. Pressurized fluid may also drain to tank 80 from acceleration channel 76 through first valve 82 via passages 108 and 109. As shown in FIGS. 4 and 5, only first valve 82 is configured to selectively drain the pressurized fluid from acceleration channel 76 to tank 80. Lift channel 68, switch channel 72, tank channel 74, and acceleration channel 76 may all protrude from cylinder 26 defining passages surrounding piston 46. Movement of piston 46 (i.e., of narrow diameter sections 54, 56, 58 and wide diameter sections 60, 62) caused by the pressurized fluid may selectively open or close the channels along cylinder 26.

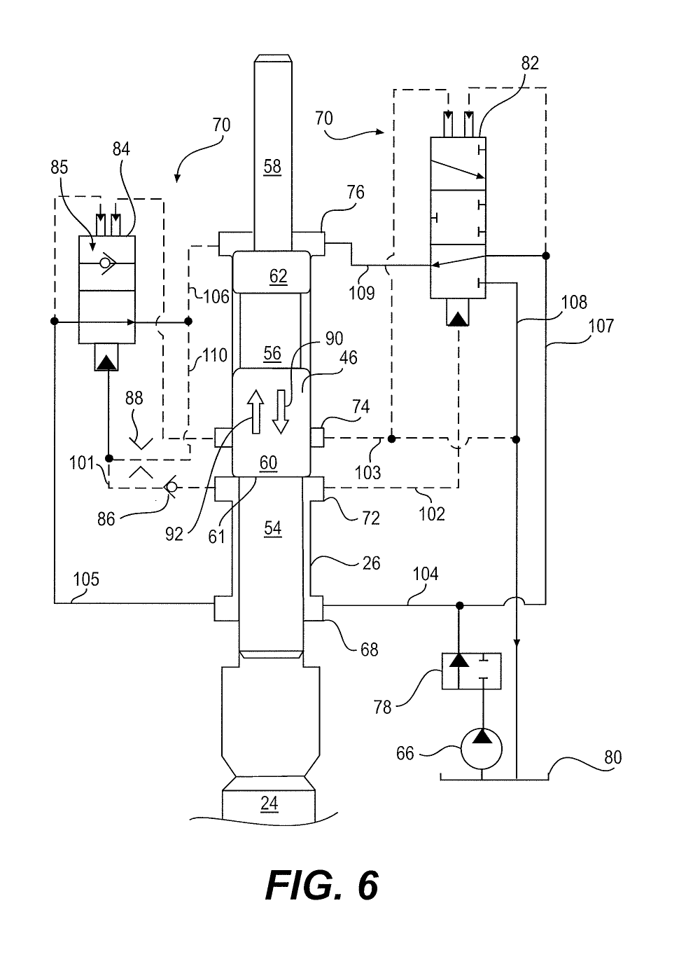

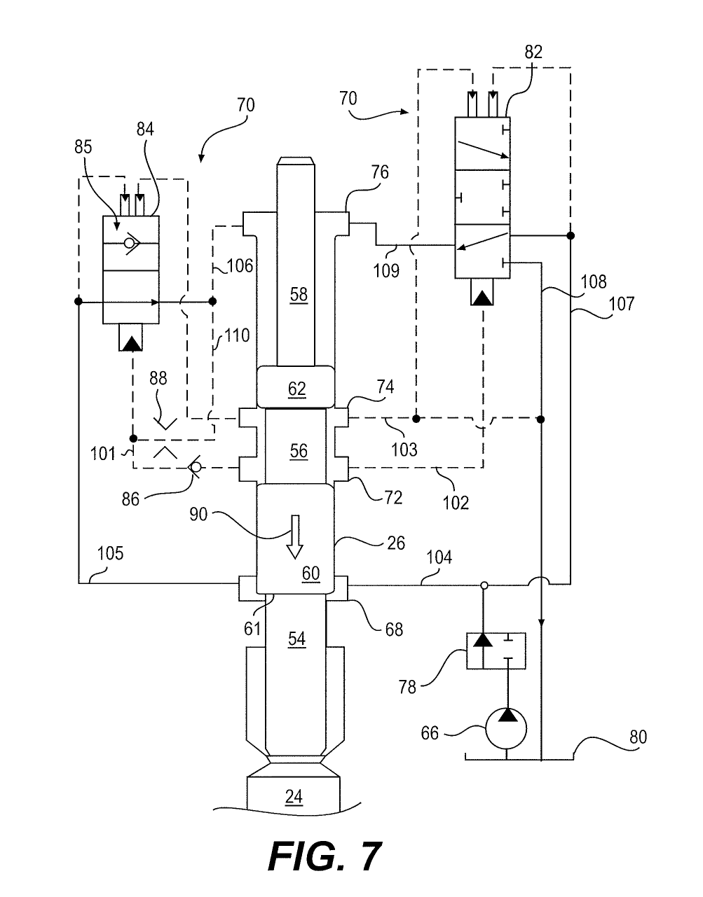

For the first and second embodiments, as shown in FIGS. 4-7, first valve 82 may be disposed between pump 66 and tank 80, and may be configured to control movements (e.g., acceleration) of piston 46. In particular, first valve 82 may control when piston 46 transitions between upward and downward movements. First valve 82 may include a valve element movable between at least two distinct positions, and may be configured to selectively supply a first portion of pressurized fluid to acceleration channel 76. As shown in FIGS. 4-7, first valve may include three distinct positions; thus, first valve 82 may be characterized as a three position, three port valve. When the valve element of first valve 82 is in the first position (upper-most position) as shown in FIGS. 4 and 5, acceleration channel 76 may be fluidly connected to tank 80. When the valve element of first valve 82 is in the second position (middle position), acceleration channel 76 may be fluidly disconnected from both pump 66 and tank 80. When the valve element of first valve 82 is in the third position (lower-most position) as shown in FIGS. 6 and 7, acceleration channel 76 may be fluidly connected to pump 66 via passages 107 and 109 and oriented to supply the first portion of pressurized fluid to acceleration channel 76. The valve element may move between the first, second, and third positions depending on a pressure level at switch channel 72. Specifically, when the pressure level at switch channel 72 is below a threshold value, the valve element of first valve 82 may be forced to the first position. Alternatively, when the pressure level within the switch channel 72 is greater than the threshold value, the valve element of first valve 82 may be forced to the third position. When first valve 82 transitions from the first position to the third position or the third position to the first position, it will transition by way of the second position. The second position may momentarily block all flow through first valve 82, which may reduce the amount of internal leakage when transitioning between positions.

In another embodiment (not shown), first valve 82 may be a two position, three port valve, which comprises just the first position and the third position as described above, thereby eliminating the second position in which all flow through first valve 82 is blocked. It is also contemplated that additional embodiments for first valve 82 may be utilized having greater or lesser numbers of positions and ports.

For the first and second embodiments, as shown in FIGS. 4-7, second valve 84 may be configured to selectively supply a second portion of pressurized fluid to acceleration channel 76. Second valve 84 may be disposed between passages 105 and 106, fluidly connecting acceleration channel 76 and lift channel 68. Second valve 84 may include a valve element movable between two distinct positions; thus, second valve 84 may be characterized as a two position, two port valve. When the valve element is in the first position (upper-most position) as shown in FIGS. 4 and 5, a check valve 85 may prevent flow of pressurized fluid from lift channel 68 via passage 105, through second valve 84, into acceleration channel 76. However, check valve 85 may allow flow of pressurized fluid from acceleration channel 76 back through second valve 84 to lift channel 68 if the pressure differential is such that flow in that direction through check valve 85 may occur. When the valve element of second valve 84 is in the second position (lower-most position) as shown in FIGS. 6 and 7, acceleration channel 76 may be fluidly connected with lift channel 68 via passages 105 and 106, thereby supplying the second portion of pressurized fluid to acceleration channel 76.

It is contemplated that other configurations for second valve 84 may be utilized. For example, second valve may be a pilot operated check valve, which can be opened by an external pilot pressure at the pilot channel. The pilot channel of the pilot check valve may be configured to connect to passages 101 or 110.

First valve 82 and second valve 84 may be positioned on opposite sides of piston 46 within cylinder 26, as shown in FIG. 3. Positioning first valve 82 and second valve 84 in this way may be advantageous for several reasons. First, the pressurized fluid flow to acceleration channel 76 may be more balanced, thereby reducing the side loading on piston 46. Second, a separate valve housing or enlarged cylinder 26 may not be required. As a result, design and construction of housing 22 may be simplified, and isolation sliding plates 38 may extend further along housing 22, thereby covering a bigger portion of cylinder 26. And third, cylinder 26 may be slimmer and lighter than it would be if only a single larger valve was utilized. Cylinder 26 being slimmer and light may also increase the overall power of hammer 12 when compared to traditional hydraulic hammers of equivalent weight.

Movement of second valve 84 from the first position to the second position may be triggered in a variety of ways. The first embodiment, as shown in FIG. 4, provides a first example of how movement of second valve 84 may be triggered. According to the first embodiment, second valve 84 may be in fluid communication with switch channel 72 via passage 101. The valve element of second valve 84 may move between the first and second positions depending on a pressure level within switch channel 72. Specifically, when the pressure level within switch channel 72 is below a threshold value, the valve element may be forced to move to the first position (upper-most position). Alternatively, when the pressure level within the switch channel 72 is greater than the threshold value, the valve element may be forced to move to the second position (lower-most position). Because both first valve 82 and second valve 84 are in fluid communication with switch channel 72, first valve 82 and second valve 84 may be configured to move positions at about the same time if the threshold pressure values for moving first valve 82 and second valve 84 are the same. Alternatively, if the threshold pressure values are different, then first valve 82 and second valve 84 may be configured to move positions independently at different times. For example, first valve 82 may be configured to move position at a lower threshold pressure value, while second valve 84 may be configured to move position at a higher threshold pressure value.

The second embodiment, as shown in FIGS. 5-7, provides a second example of how movement of second valve 84 may be triggered. According to the second embodiment, check valve 86 may be disposed in passage 101 fluidly disconnecting second valve 84 with switch channel 72, thereby preventing the fluid pressure of the switch channel 72 from triggering the movement of second valve 84. Instead, second valve 84 may be in fluid communication with acceleration channel 76 via passage 106 and 110. Therefore, according to the second embodiment, second valve 84 may be configured to move positions based on the pressure level in acceleration channel 76 rather than the pressure level in switch channel 72 as is the case for the first embodiment. As shown in FIGS. 5-7, according to the second embodiment, orifice 88 may be disposed in passage 110 between second valve 84 and acceleration channel 76 to limit the flow rate of pressurized fluid to second valve 84.

It is contemplated that additional methods for triggering the movement of second valve 84 between the first position and the second position may also be utilized. For example, passage 110 may be directly connected to first valve 82 in addition to acceleration channel 76. Therefore, second valve 84 movement may be dependent not only on the pressure in acceleration channel 76, but also directly dependent on the position of first valve 82. As a result, first valve 82 may open and close this connection. By first valve 82 opening and closing this connection, check valve 86 and orifice 88 may be eliminated.

It is also contemplated that hammer 12 may include other orifices, valves, channels, and/or other components in addition to those included in dual valve acceleration control system 70 as described in reference to the first embodiment (FIG. 4) and second embodiment (FIGS. 5-7). For example, according to other embodiments, dual valve acceleration control system 70 may include additional valves besides first valve 82 and second valve 84. One or more additional valves may be used to supplement operation of first valve 82 and/or second valve 84. For example, one or more additional valves (e.g., 1, 2, 3, 4, 5, or more) may be used in conjunction with second valve 84. The one or more additional valves may be connected in parallel with second valve 84 and thus the operation may be the same as second valve 84. In yet another example, one or more additional valves may be used in conjunction with first valve 82. The one or more additional valves may be connected in parallel with first valve 82 and thus the operation may be the same as first valve 82. Utilizing additional valves may enable the size of the hammer and piston to get larger or valve sizes to be reduced further. When utilizing additional valves, first valve 82, second valve 84, and the one or more additional valves may be spaced evenly around piston 46.

### INDUSTRIAL APPLICABILITY

The disclosed dual valve acceleration control system may be used in any hydraulic hammer, including large hydraulic hammers (e.g., those weighing more than 1000 kg), which traditionally require large control valves to allow sufficient fluid transfer to move their large pistons without increasing fluid pressure. By using a first valve and a second valve, fluid transfer can be divided (e.g., evenly or non-evenly) between the two valves, thereby allowing each valve to be of smaller size than when a single larger control valve is utilized for an equivalent size hydraulic hammer. The reduced size of the first and second valves can enable the valves to be positioned within the piston housing and thereby eliminate the need for a separate valve housing as is often used for larger hydraulic hammers. Utilizing first and second valves as described herein may allow the first valve to be about half the size than the larger single valve for an equivalent size hammer. Operation of hammer 12 will now be described primarily with reference to FIGS. 5, 6, and 7 (i.e., the second embodiment); however, the operation description is equally applicable to the first embodiment of FIG. 4. FIG. 4 will be referenced when explaining the difference in operation of the first and second embodiments.

Referring to FIG. 5, an operator request may be made to begin operation of hammer 12 via, for example, an operator valve 78. After the request is made, pump 66 may direct pressurized fluid, for example oil, into lift channel 68 via passage 104. Pressurized fluid supplied to lift channel 68 may apply a pressure on piston 46. Specifically, the pressurized fluid within lift channel 68 may apply a pressure to shoulder 61 of wide diameter section 60 and bias piston 46 upward in second direction 92. During this operation, the valve element of first valve 82 may be in the first position such that acceleration channel 76 is in fluid communication with tank 80. Therefore, as piston 46 slides upward in second direction 92 as a result of the pressure in lift channel 68, fluid within acceleration channel 76 can drain to tank 80 as the volume of acceleration channel 76 decreases as a result of the approaching wide diameter section 62. Also during this operation, the valve element of second valve 84 may be in the first position, thereby check valve 85 may prevent flow of pressurized fluid from lift channel 68 into acceleration channel 76.

As shown in FIG. 6, movement of piston 46 in second direction 92 may open switch channel 72. Specifically, movement of piston 46 upward in second direction 92 may correspondingly move narrow diameter section 54 to a location adjacent to switch channel 72. While switch channel 72 is uncovered, pressurized fluid may flow from lift channel 68 along narrow diameter section 54 into switch channel 72, thereby increasing the pressure level at switch channel 72 and causing first valve 82 to be moved from the first position (upper-most position) to the third position (lower-most position). As shown in FIG. 6, for the second embodiment, check valve 86 will prevent the pressure at switch channel 72 from reaching and thereby moving second valve 84. Instead, movement of second valve 84 from the first position to the second position may be driven by (e.g., dependent on) first valve 82 first supplying a first portion of pressurized fluid to acceleration channel 76. Acceleration channel 76 may be in fluid communication with the second valve 84 via passages 106 and 110. As a result, the first portion of pressurized fluid may supply pressure fluid to second valve 84, thereby causing second valve 84 to move from first position (upper-most position) to the second position (lower-most position). In other words, second valve 84 may be configured to supply the second portion of the pressurized fluid only after first valve 82 begins to supply the first portion of the pressurized fluid.

For the first embodiment shown in FIG. 4, when the pressure level at switch channel 72 is increased as a result of pressurized fluid flowing up from lift channel 68, second valve 84 may move from the first position to the second position because of the direct supply of pressurized fluid to second valve 84 via passage 101. For this embodiment, although first valve 82 and second valve 84 both move positions based on pressure at switch channel 72, their movement may be independent of one another. For example, as described above, the pressure threshold value at which each valve moves may be different.

When both first valve 82 and second valve 84 have moved their valve element positions, as shown in FIG. 6, the first portion of pressurized fluid from pump 66 may flow through first valve 82 into acceleration channel 76, and the second portion of pressurized fluid from lift channel 68 may flow through second valve 84 into acceleration channel 76. The first portion of pressurized fluid may have a volume less than, equal to, or greater than the second portion of pressurized fluid. According to one embodiment, when first valve 82 is larger (i.e., has a greater flow capacity) than second valve 84, the first portion of pressurized fluid supplied to acceleration channel 76 may have a greater volume than the second portion of pressurized fluid. In another embodiment, when first valve 82 and second valve 84 are the same size (i.e., have the same flow capacity), the first portion of pressurized fluid supplied to acceleration channel 76 may have a greater volume because first valve 82 may move position before second valve 84.

As a result of pressurized fluid (e.g., first portion and second portion) flowing through first valve 82 and second valve 84 into acceleration channel 76, piston 46 will switch the direction of movement from second direction 92 to first direction 90, as shown in FIG. 6. Piston 46 may then be accelerated downward in first direction 90 to impact work tool 24 due to the flow of pressurized fluid (e.g., first portion and second portion) into acceleration channel 76. It is also contemplated that dual valve acceleration control system 70 may be configured such that piston 46 may switch direction based on flow of just the first portion of pressurized fluid through first valve 82 and then the second portion of pressurized fluid through second valve 84 may be supplied to acceleration channel 76 to acceleration piston 46 in first direction 90.

As shown in FIG. 6, the acceleration of piston 46 in first direction 90 will cause wide diameter section 60 to move toward lift channel 68, thereby displacing the fluid within lift channel 68. Displacing fluid from lift channel 68 may facilitate an additional flow of pressurized fluid to acceleration channel 76 via, for example, second valve 84. Upon piston 46 reaching an impacting position (as shown in FIG. 7), switch channel 72 may become fluidly connected with tank channel 74 by way of the annular space around narrow diameter section 56. Fluidly connecting switch channel 72 and tank channel 74 may allow fluid within the channels to drain back to tank 80, thereby lowering the pressure level at switch channel 72. Lowering the pressure at switch channel 72 causes first valve 82 and second valve 84 to move back to their first positions as originally shown in FIG. 5. The impact of work tool 24 with the material (not shown) may cause piston 46 to recoil. Following impact and the switching of first valve 82 and second valve 84 back to their first position, the process may automatically restart so long as operator valve 78 remains open.

There may be pressure peaks within acceleration channel 76 when piston 46 shifts movement from second direction 92 to first direction 90 and vice versa. Pressure peaks can cause untimely direction switching of piston 46, as well as untimely position switching of at least first valve 82. To reduce the magnitude of pressure peaks in acceleration channel 76, pressurized fluid may flow back to high pressure lines (e.g., lift channel 68) through second valve 84 when in either the first position or the second position. Reducing the magnitude of the pressure peaks can help maintain proper timing of first valve 82 with piston 46 movements, thereby enabling a more efficient operation.

It will be apparent to those skilled in the art that various modifications and variations can be made to the disclosed systems. Other embodiments will be apparent to those skilled in the art from consideration of the specification and practice of the disclosed systems. It is intended that the specification and examples be considered as exemplary only, with a true scope being indicated by the following claims and their equivalents.

What is claimed is:

1. A hydraulic hammer, comprising:
a housing;
a piston configured to reciprocate within the housing;
an acceleration channel formed within the housing, and configured to receive a pressurized fluid for accelerating the piston in a first direction;
a first valve in communication with the acceleration channel, and configured to selectively supply a first portion of the pressurized fluid to the acceleration channel; and
a second valve in communication with the acceleration channel, and configured to selectively supply a second portion of the pressurized fluid to the acceleration channel.

2. The hydraulic hammer of claim 1, wherein the first valve and the second valve are positioned within the housing.

3. The hydraulic hammer of claim 2, wherein the first valve and the second valve are positioned on opposite sides of the housing.

4. The hydraulic hammer of claim 3, wherein the first portion of pressurized fluid and the second portion of pressurized fluid supplied to the acceleration channel are configured to be balanced, thereby reducing the side loading on the piston.

5. The hydraulic hammer of claim 1, wherein only the first valve is configured to selectively drain the pressurized fluid from the acceleration channel to a tank.

6. The hydraulic hammer of claim 1, wherein the second valve is configured to reduce pressure peaks within the acceleration channel by allowing reverse flow of the pressurized fluid through the second valve.

7. The hydraulic hammer of claim 1, including:
a lift channel formed around the piston, and in fluid communication with a pump and the second valve, the lift channel being configured to receive pressurized fluid for accelerating the piston in a second direction opposite the first direction; and
a switch channel formed around the piston, and configured to move positions of the first valve and the second valve based on the pressure of pressurized fluid within the switch channel.

8. The hydraulic hammer of claim 1, wherein the first valve and the second valve have an equal flow capacity to the acceleration channel.

9. The hydraulic hammer of claim 1, wherein the first valve has a greater flow capacity to the acceleration channel than the second valve.

10. A valve control system for a piston associated with an acceleration channel, comprising:
a first valve in communication with the acceleration channel, and configured to selectively supply a first portion of a pressurized fluid to the acceleration channel; and
a second valve in communication with the acceleration channel, and configured to selectively supply a second portion of the pressurized fluid to the acceleration channel only after the first valve begins to supply the first portion of the pressurized fluid.

11. The valve control system of claim 10, wherein the second valve is configured to supply the second portion of the pressurized fluid in response to a pressure of the first portion of the pressurized fluid in the acceleration channel.

12. The valve control system of claim 10, wherein the first valve and the second valve are positioned within and on opposite sides of a housing configured to contain the piston.

13. The valve control system of claim 10, wherein the first portion of pressurized fluid and the second portion of pressurized fluid supplied to the acceleration channel are configured to be balanced, thereby reducing the side loading on the piston.

14. The valve control system of claim 10, wherein only the first valve is configured to selectively drain the pressurized fluid from the acceleration channel to a tank.

15. The valve control system of claim 10, wherein the second valve is configured to reduce pressure peaks within the acceleration channel by allowing reverse flow of the pressurized fluid through the second valve.

16. The valve control system of claim 10, wherein the first valve and the second valve have an equal flow capacity to the acceleration channel.

17. The valve control system of claim 10, wherein the first valve has a greater flow capacity to the acceleration channel than the second valve.

18. A valve control system for a piston associated with an acceleration channel, comprising:
a first valve in communication with the acceleration channel, and configured to selectively supply a first portion of a pressurized fluid to the acceleration channel; and
a second valve in communication with the acceleration channel, and configured to selectively supply a second portion of the pressurized fluid to the acceleration channel;
wherein the first valve and the second valve supply the first portion and the second portion of the pressurized fluid independently of each other and based on a position of the piston.

19. The valve control system of claim 18, wherein the first valve is configured to begin supplying the first portion of the pressurized fluid before the second valve begins supplying the second portion of the pressurized fluid.

20. The valve control system of claim 18, wherein the second valve is configured to reduce pressure peaks within the acceleration channel by allowing reverse flow of the pressurized fluid through the second valve.
